(19) United States
(12) Patent Application Publication
(10) Pub. No.: US 2017/0139923 A1
(43) Pub. Date: May 18, 2017

(54) SEARCHING METHOD FOR PRODUCT IMAGE AND SEARCHING SYSTEM FOR PRODUCT IMAGE

(71) Applicant: INSTITUTE FOR INFORMATION INDUSTRY, Taipei (TW)

(72) Inventors: Jing-Wei Wang, Taipei City (TW); Jung-Hsuan Lin, Taipei City (TW); Rong-Sheng Wang, Taipei City (TW); Shih-Chun Chou, Taipei City (TW)

(21) Appl. No.: 15/135,718

(22) Filed: Apr. 22, 2016

(30) Foreign Application Priority Data
Nov. 18, 2015 (TW) 104138067

(51) Int. Cl. G06F 17/30; G06K 9/62; G06Q 30/06

(52) U.S. Cl. CPC G06F 17/3053; G06F 17/30247; G06Q 30/0625; G06K 9/6215

(57) ABSTRACT

A searching method for product photograph is provided. An input image is provided and delivered to a server from a client terminal, and the user selects a searching option from the client. According to the selected searching option, the input image is analyzed to obtain searching data. A comparison process is performed by comparing the input image and the searching data corresponding to the input image to a plurality of product images and a plurality of properties corresponding to those product images. At least one of those product images is delivered to the user for displaying.

### RELATED APPLICATIONS

This application claims priority to Taiwan Application Serial Number 104138067, filed Nov. 18, 2015, which is herein incorporated by reference.

### BACKGROUND

Field of Invention

The present invention relates to a searching method and a searching system. More particularly, the present invention relates to a searching method for product image and a searching system for product image.

Description of Related Art

In recent mobile commerce, users usually use the image recognition technology to search the target product they want. The existing image recognition technology usually provides a searching area, which can be selected by the users, to avoid the error of the searching result. Generally speaking, the search is only for comparing the similarity one of the image, scenario and classified data. In this manner, the method only can find out the image similar to the original image or the classified data similar to the data of the original image. However, users often have different requests. Sometimes users want to search the product having similar looking with the product in original image. Sometimes users want to search the product belonging to the same brand as the product in original image. Sometimes users want to search the similar product as the product in original image. So far, the simple image recognition technology only can find the similar images. The simple image recognition technology cannot always find the product that users want.

### SUMMARY

The invention provides a searching method for product images. The searching method for product images comprises following steps: providing an input image, the input image being transmitted from a client terminal to a server and one of a plurality of searching options being selected by the client terminal; analyzing the input image according to the searching options for obtaining searching data; performing a comparison process, the input image and the searching data being compared with a plurality of product images and a plurality of properties corresponding to the product images in a database of the server during the comparison process; and delivering at least one display product image to the client terminal for displaying.

The invention provides a searching system for product images. The searching system for product images comprises a database, a calculation comparison unit and an electronic device. The database comprises a plurality of product images, wherein each product image corresponding to a plurality of properties. The electronic device wirelessly is communicated with the sever terminal. The electronic device comprises an image providing unit, an input interface and a control unit. The image providing unit is configured to provide an input image. The input interface is configured to provide a plurality of searching options for a user to select from. The control unit is configured to transmit the input image and the searching options to the server. wherein the calculation comparison unit of the server analyzes the input image to obtain searching data corresponding to the searching options, performs a comparison process of comparing the input image and the corresponding searching data with the product images and the corresponding properties in the database, so as to select at least one display product image from the product images, and deliver the at least one display product image to the electronic device for displaying.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 depicts a block diagram of a searching system for product image according to one embodiment of this invention;

FIG. 2 depicts a schematic diagram of a scenario according to one embodiment of this invention;

FIG. 3 depicts a schematic diagram of an input image according to one embodiment of this invention;

FIG. 4 depicts a block diagram of an input interface according to one embodiment of this invention;

FIG. 5 depicts a flowchart of a searching method for product image according to one embodiment of this invention; and

FIG. 6A to FIG. 6F depict schematic diagrams of product image according to one embodiment of this invention.

### DETAILED DESCRIPTION

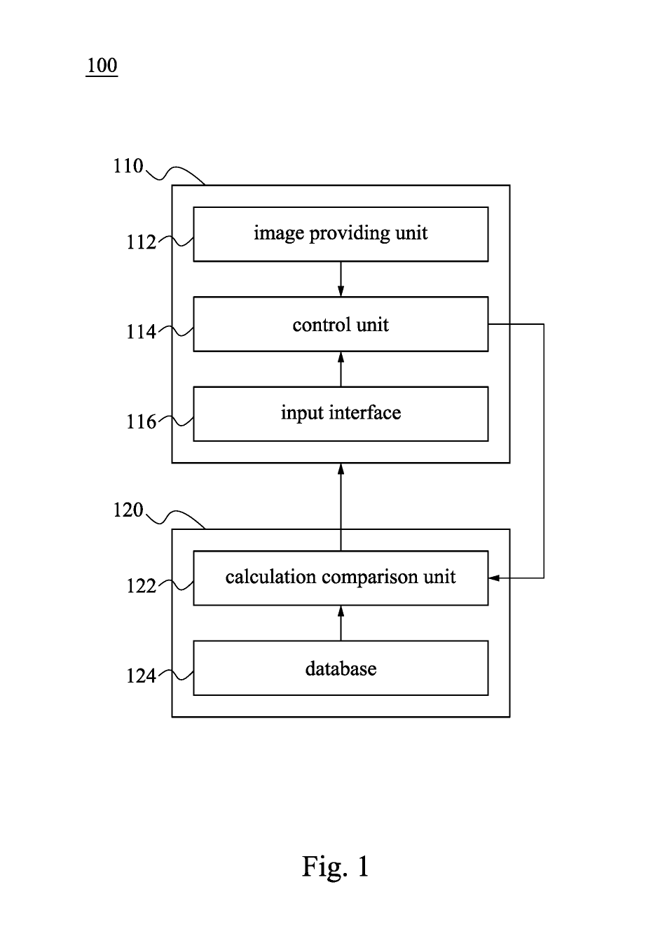

FIG. 1 depicts a block diagram of a searching system for product image 100 according to one embodiment of this invention. The searching system for product images 100 includes an electronic device 110 and a server 120. The electronic device 110 can be a smart phone, a panel, a notebook computer or other portable smart device, which can wirelessly communicate to the server 120 by the wireless communication network. In present invention, the electronic device 110 represents the user terminal, which corresponds to the server 120. Wherein the electronic device 110 includes an image providing unit 112, a control unit 114 and an input interface 116. The image providing unit 112 is configured to provide an input image. The input interface 116 is configured to provide multiple searching options for a user to select from. The control unit 114 is configured to transmit the input image and the searching options to the server 120. The server 120 includes a calculation comparison unit 122 and a database 124. The database 124 is configured to store multiple product images. Each product image corresponding to multiple properties. The calculation comparison unit 122 analyzes the input image to obtain the searching data corresponding to the searching option, performs a comparison process of comparing the input image and the searching data with the product images and the corresponding properties in the database 124, so as to select at least one display product image from the product images, and delivers one or more display product image to transmit to the electronic device 110 for displaying.

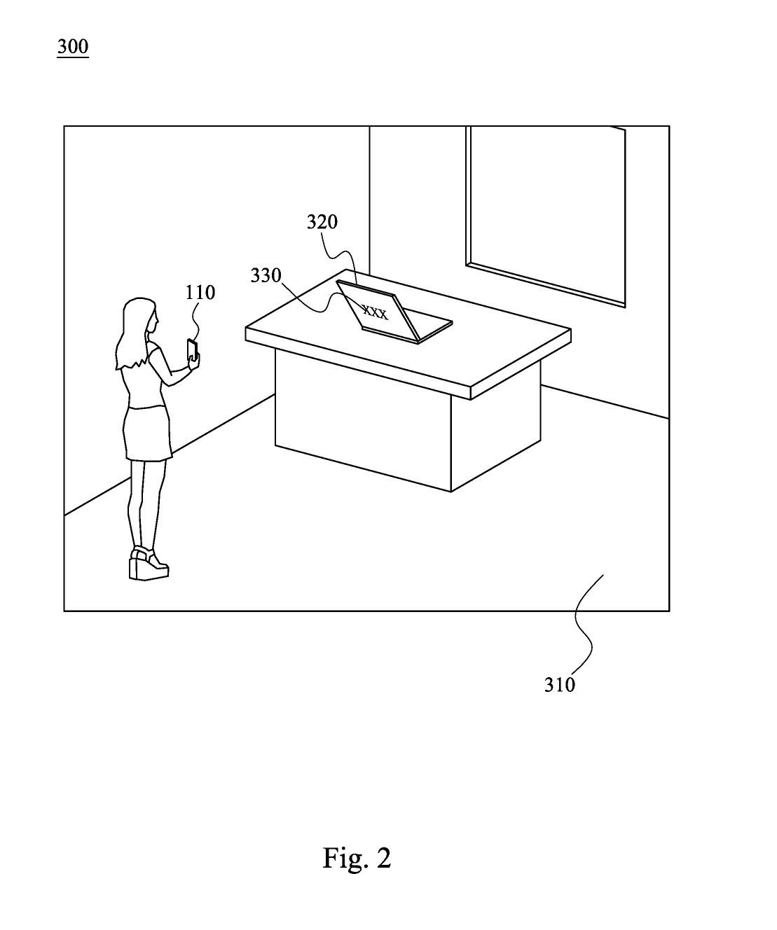

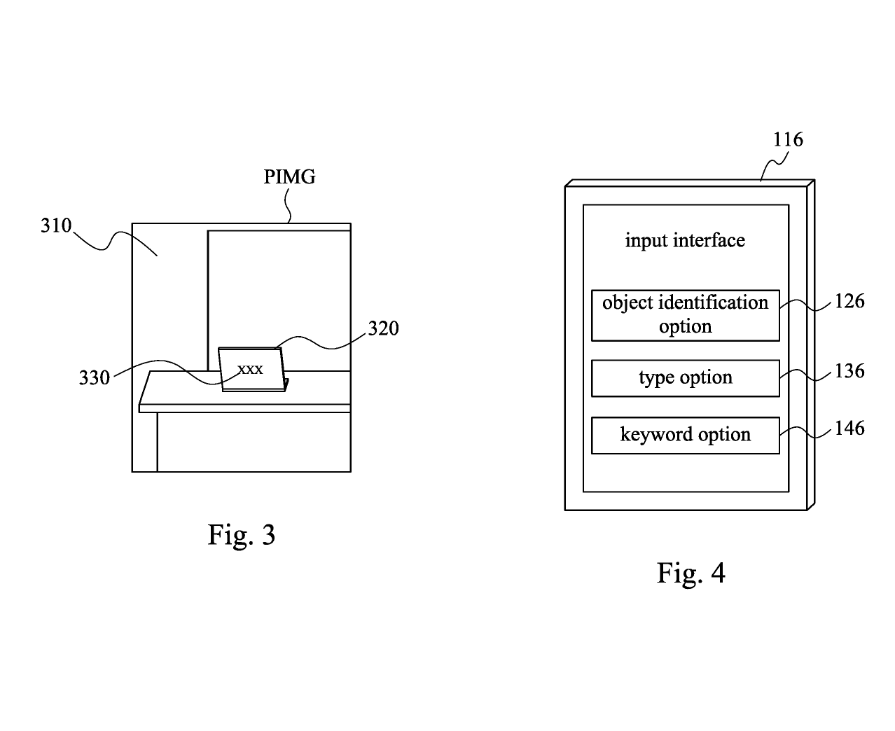

A description is provided with reference to FIG. 2 and FIG. 3. FIG. 2 depicts a schematic diagram of a scenario 300 according to one embodiment of this invention. FIG. 3 depicts a schematic diagram of an input image PIMG according to one embodiment of this invention. In one embodiment, the user in the scenario 300 holds the electronic device 110 for capturing images. As shown in FIG. 3, the input image PIMG includes the scenario feature 310, the object 320 and the words 330 of the object 320. The scenario 300 can be the indoor place, such as office, conference hall or exhibition hall. Also, the scenario 300 can be the outdoor place, such as sports stadium or park.

The description is further provided with reference to FIG. 4. FIG. 4 depicts a block diagram of an input interface 116 according to one embodiment of this invention. The input interface 116 is configured to provide searching options. Wherein the searching options can include an object identification option 126, a type option 136 and a keyword option 146, not limited thereto. Each searching option corresponds to a weight, and the weight can be adjusted by the user. The weight corresponding to the searching options can be any number. For example, the weight of the object identification option 126 is 0.25, the weight of the type option 136 is 0.75, and the weight of the keyword option 146 is 1. The value of the weight above mentioned is only for the examples, not limited thereto. In other embodiment, the input interface 116 can further include other types of searching options, such as a style option, a brand option, a product name option, an image description option, a price option or a place of origin option. These searching options are not shown in figures. However, those skilled in the art can understand the scope of the present invention, not limited by the embodiment mentioned above.

The control unit 114 is configured to transmit the input image PIMG and the searching options to the server 120. Wherein the input image PIMG is provided by the image providing unit 112, and the searching options is selected from the input interface 116. The database 124 in the server 120 stores multiple product images. The product images herein can include the images belonging to the different field, such as electronic products, the daily necessities, shoes, clothes, food, books, etc. Wherein each product image of the database 124 has multiple properties. The calculation comparison unit 122 analyzes the input image PIMG to obtain the searching data corresponding to the selected searching options, and performs a comparison process of comparing the input image PIMG and the corresponding searching data with the multiple product images and the corresponding properties of product images in the database 124. The properties can be the keywords, brands, product types, styles, other accessories or years in product images, etc. In some particular embodiments, the selected searching option(s) can be one or more. When the multiple selected searching options exist, the comparison process can be performed by using the weight above mentioned. The specific method will be described in following paragraphs.

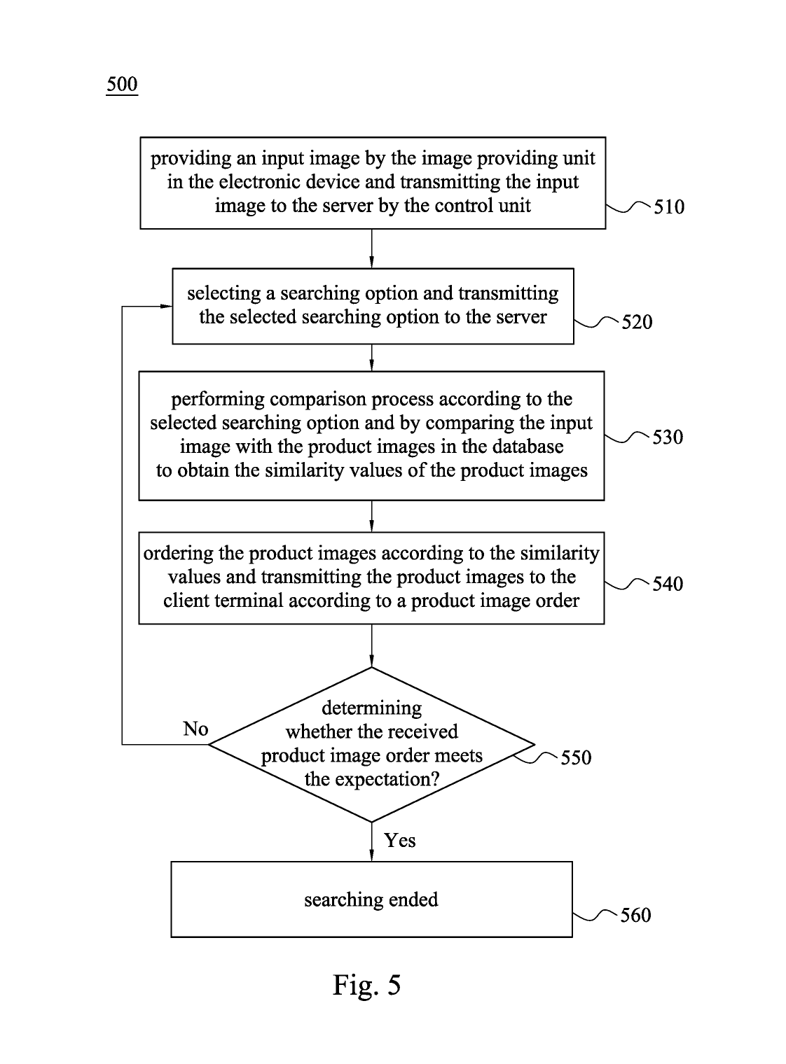

The description is further provided with reference to FIG. 5. FIG. 5 depicts a flowchart of a searching method for product image 500 according to one embodiment of this invention. Firstly, in step 510, user provides an input image by the image providing unit 112 in the electronic device 110. And, the input image is transmitted to the control unit 114. Wherein the input image providing method of the image providing unit 112 can be implemented by directly downloading the image from the internet or captured the image by the camera in real time. In one embodiment of present invention, user holds the electronic device 110 to capture the image of scenario 300. As shown in FIG. 3, the image providing unit 112 provides the captured input image PIMG. And, the control unit 114 transmits the input image PIMG to the calculation comparison unit 122 of the server 120.

In another aspect, in the next step 520, the input interface 116 in the electronic device 110 selects a searching option and transmits the selected searching option to the calculation comparison unit 122 of the server 120. In this embodiment, the input interface 116 displays the select button or the select window corresponding to the object identification option 126, type option 136 and keyword option 146. When the user clicks the object identification option 126 on the input interface 116, the object identification option 126 can be transmitted to the calculation comparison unit 122 of the server 120. Similarly, when user clicks the type option 136 or the keyword option 146, the type option 136 or the keyword option 146 can be transmitted to the calculation comparison unit 122 of the server 120 for performing the following comparison process.

In another embodiment, the searching option also can be selected automatically by the system. That is, the system can help user to select a searching option from the input interface 116 according to the configurations of the server 120. In this way, user does not need to determine the searching option by himself/herself. In another embodiment, the searching option can be determined by a learning mode. In other words, the system can help user to select a searching option from the input interface 116 according to the searching record inputted by the user in the past for determining the user's searching preference.

During the comparison process performed by the calculation comparison unit 122, the selected searching option can be the only one option (without considering other searching options). Or, the selected searching option can be configured to have the higher weight relative to the unselected searching option. For example, if the object identification option 126 is configured as the searching option, the weight is assigned as 1. The weights of other unselected type option 136 and unselected keyword option 146 are separately assigned as 0.5. Similarly, the method can be applied to the situation that the type option 136 or the keyword option 146 is selected as the searching option. However, the values of weights are used for the example, not limited thereto.

After selecting one of the searching options from the input interface 116, the calculation comparison unit 122 in server 120 receives the input image PIMG and the selected searching option. Then, step 530 is performed to processing the comparison process. The comparison process includes a similarity comparison process and a data comparison process of image themselves. The similarity comparison process is used for obtaining similarity comparison values by respectively comparing the overall appearance of the input image PIMG with the overall appearance of multiple product images stored in the database 124. Wherein the overall appearance includes the shape, color, size or material of the pattern. On the other hand, the data comparison process is used for obtaining data comparison values by respectively comparing the searching data with the properties corresponding to the multiple product images stored in the database 124. The properties herein can be the keywords, brands or types in images, etc.

In present embodiment, the object identification option 126 corresponds to the similarity comparison process above mentioned. That is, the system compares the overall appearance including the shape, color, size or material of the scenario feature 310, the object 320 and the words 330 in the input image PIMG with the overall appearance including the shape, color, size or material of the patterns in the product image stored in the database 124, so as to obtain the similarity comparison values.

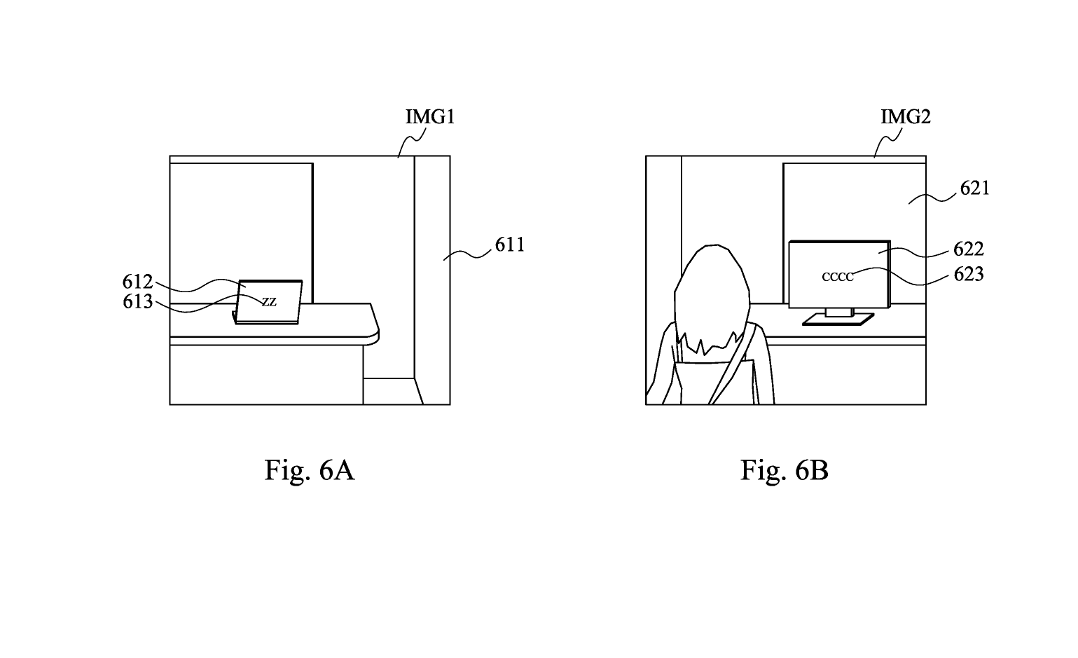

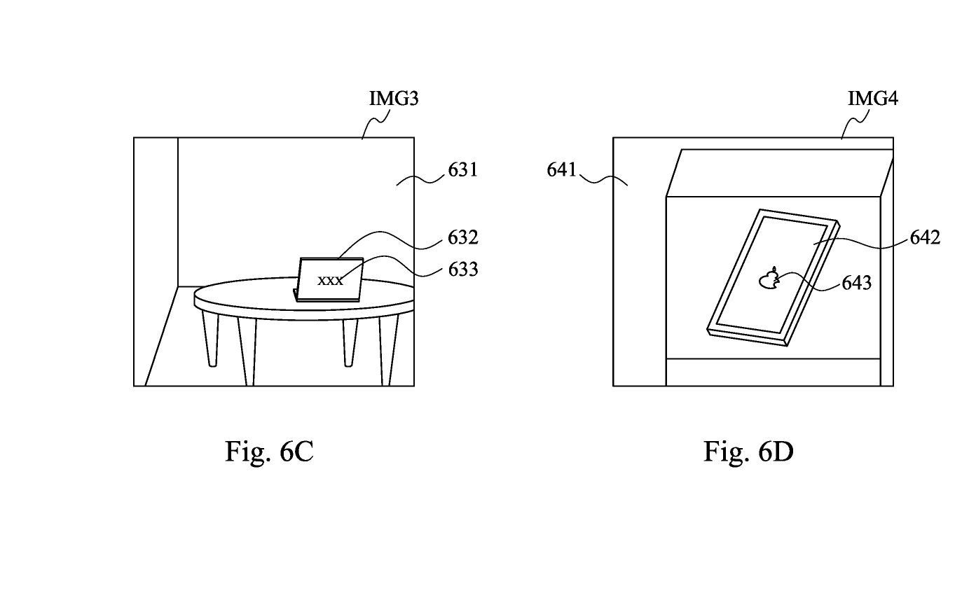

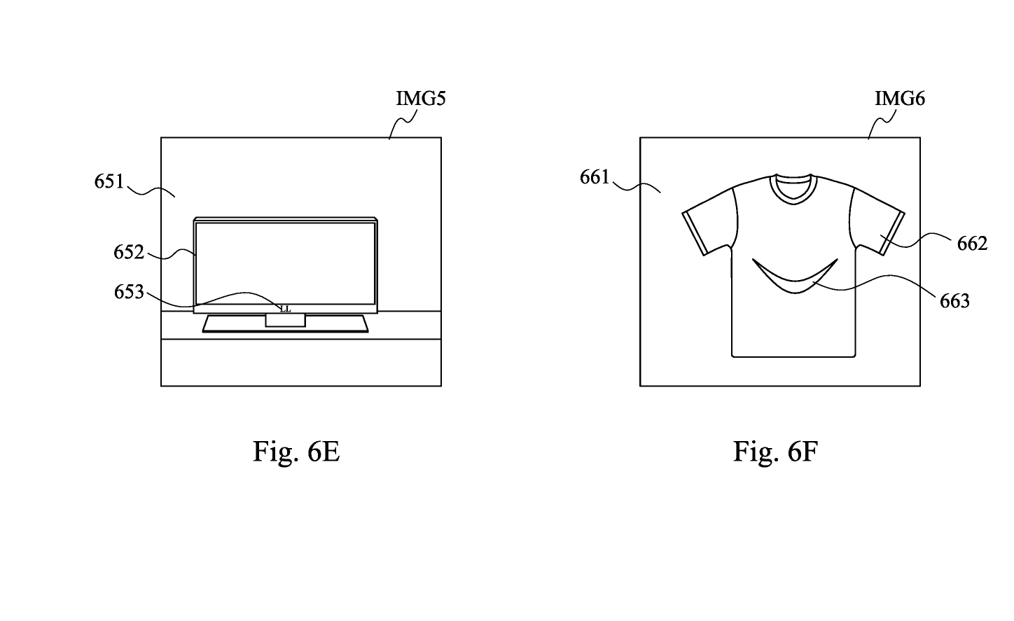

A description is provided with reference to FIG. 6A to FIG. 6F. FIG. 6A to FIG. 6F depict schematic diagrams of product image IMG1 to IMG6 according to one embodiment of this invention. As mentioned above, the calculation comparison unit 122 compares the overall appearance including the shape, color, size or material of the scenario feature 310, the object 320 and the words 330 in the input image PIMG with the overall appearance including the shape, color, size or material of the patterns of each product image IMG1-IMG6 stored in the database 124. In this way, the method will give the highest similarity value to the product image, which is most similar to the overall appearance of the input image PIMG. In addition, the similarity value is determined smaller corresponding to the progressively decreasing similarity.

In the embodiment, by comparing the image itself, the overall appearance of the input image PIMG is that a notebook computer places on the desk. The input image PIMG is used for comparing to the overall appearance of the product image IMG1-IMG6. Wherein the product images IMG1-IMG6 comprise scenarios 611-661, objects 612-662 and words or brand logos 613-663. Wherein the product image IMG1 has the most similar overall appearance compared with the input image PIMG. Therefore, the product image IMG1 obtains the highest similarity value. And, the similarity value is determined smaller corresponding to the progressively decreasing similarity. Comparing to the input image PIMG, the product image IMG6 has the largest different overall appearance compared with the input image PIMG. As such, the product image IMG6 obtains the lowest similarity value. In this way, the system can obtain the similarity values as [300, 220, 150, 90, 50, 10] corresponding to the product images IMG1-IMG6. However, those skilled in the art can understand that the similarity values are used for the example, not limited by the embodiment mentioned above.

In another aspect, in the embodiment, the type option 136 and the keyword option 146 correspond to the data comparison process above mentioned. When the type option 136 represents that assuming the foreground object of input image PIMG is vague, without the logo or the shape characteristic can be clearly identified, or the object identified method cannot capture the specific foreground object from the input image PIMG, the scenario feature of the input PIMG can be adopted as the searching data. The scenario feature means that the identification can be performed according to the color, color distribution, texture and edge feature of the whole image. The data comparison values are obtained by comparing multiple scenario features included in multiple product images of the database 124. That is, the data comparison values are obtained by comparing the properties of the product images. In the embodiment, the input image PIMG includes the scenario feature 310, the object 320 and the words 330. The foreground object, such as the object 320 and the words 330, cannot clearly identified from the input image PIMG. Therefore, as mentioned above, the system adopts the method that the data comparison values are obtained by comparing the scenario feature 310 with the multiple scenario features included in multiple product images of the database 124.

In the embodiment, the calculation comparison unit 122 determines the scenario feature 310 of the whole input image PIMG as the searching data. Wherein the whole scenario feature 310 is an office scenario. The system compares each scenario feature of product images IMG1-IMG6 with the scenario feature 310. Wherein the whole product images IMG1-IMG3 include the scenario features 611, 621 and 631. The scenario features 611, 621 and 631 are the similar office scenarios. Wherein the scenario feature 621 of the product image IMG2 is the most similar to the scenario feature 310 of the product image IMG1. Therefore, the product image IMG2 obtains the highest data comparison value. Comparing the scenario feature 611 of the product image IMG1 and the scenario feature 631 of the product image IMG3 with the scenario feature 310 of the input image PIMG, the scenario feature 611 of the product image IMG1 is more similar to the input image PI MG than the scenario of the product image IMG3. Other scenario features 641, 654 and 661 of the product images IMG4-IMG6 are not similar to the office scenario. As such, the scenario features 641, 654 and 661 obtain the lower data comparison values. Thus, the product images IMG1-IMG6 can obtain the data comparison values as [180, 250, 150, 70, 30, 5]. However, those skilled in the art can understand that the data comparison values are used for the example, not limited by the embodiment mentioned above.

On another aspect, the keyword option 146 determines the words as searching data. Wherein the words are identified from the input image PIMG by the character recognition method. In addition, the system compares the searching data with the words included in the multiple product images in the database 124. That is, the system compares the searching data with the properties of the product image for obtaining the data comparison values. For example, as shown in FIG. 3, the keyword option 146 identified the words 330 included in the input image PIMG. In some embodiment, the character recognition method can be the optical character recognition (OCR) or metadata, not limited thereto.

In the embodiment, the calculation comparison unit 122 uses the character recognition method to identify the words 330 included in the input image PIMG. And, the calculation comparison unit 122 compares the words 330 with the words included in the product images IMG1-IMG6 of FIG. 6A-FIG. 6F. The words 330 identified from the input PIMG are XXX. And, the words 613, 623, 633 and 653 are identified from the product images IMG1-IMG3 and IMG5. The words 633 identified from the product image IMG3 are XXX, which are the same as the words 330 identified from the input image PIMG. Thus, the product image IMG3 can obtain the highest data comparison value. On the other hand, the product images IMG4 and IMG6 only include the brand logo 643 and 633. The product images IMG4 and IMG6 cannot be identified any words. As such, comparing to the product image IMG3, the product images IMG4 and IMG6 obtain the lower data comparison value. According to the recognition method, the product images IMG1-IMG6 can obtain the data comparison values as [150, 280, 350, 15, 120, 8]. However, those skilled in the art can understand that the data comparison values are used for the example, not limited by the embodiment mentioned above.

It should be noticed that when a searching option is selected, the calculation comparison unit 122 sometimes not only considers the selected searching option. The calculation comparison unit 122 has to consider the searching option(s) that is/are not be selected, so as to further calculate the similarity comparison values and data comparison values. In this moment, the weights corresponding to the selected searching option needs to be further considered during the comparison process to provide the final product image order. When a searching option is selected, the searching option will have the highest weight. That is, user determines that the searching option is the most important factor while searching the product images. Besides, the unselected searching options have the lower weights. It means that user determines that the unselected searching options are the second factors, which is not important relatively to the selected searching options while searching product images. For example, in the embodiment, when user searches the product image according to the input image and user considers the keyword option is more important, the user selects the keyword option as the searching option. In this moment, the weight corresponds to the keyword option is assigned as 1. Other unselected searching options are the object identification option and type option, and the weights correspond to the object identification option and type option are smaller than 1, such as 0.5 or 0.25. Based on the same method, in this embodiment, when user selects the object identification option or the type option, the selected option will have the higher similarity comparison weight or the higher data comparison weight relatively to the other two unselected searching options. The specific description is mentioned as above, not described herein.

When the searching option is selected, in step 530, the calculation comparison unit 122 further obtains the similarity value by multiplying the similarity comparison values by similarity comparison weight according to the selected searching option and then adding that the data comparison value multiplying by the data comparison weight, so as to determine the product image order.

For example, as an example of present invention, when the selected object identification option 126 is determined as the searching option, the similarity comparison weight of the object identification option 126 is assigned as 1. The data comparison weights of the unselected searching options, such as the type option 136 and the keyword option 146, are assigned as 0.25. Then, the similarity comparison values of the input image PIMG and the similarity comparison values of each product images IMG1-IMG6 are calculated according to the similarity comparison process corresponded to the object identification option 126, e.g. multiplying [300, 220, 150, 90, 50, 10] by the similarity comparison weight 1, and then adding the result of multiplying the data comparison values of input image PIMG and each produce image IMG1-IMG6 calculated by the data comparison processes separately corresponding to the type option 136 and the keyword option 146, such as [180, 250, 150, 70, 30, 5] and [150, 280, 350, 15, 120, 8], by the data comparison weight 0.25 and 0.25, so as to calculate the similarity value.

Based on above, the similarity value of the product image IMG1 is 300*1+1 80*0.25+150*0.25=382.5, the similarity value of the product image IMG2 is 220*1+250*0.25+280*0.25=352.5, the similarity value of the product image IMG3 is 150*1+150*0.25+350*0.25=275, the similarity value of the product image IMG4 is 90*1+70*0.25+15*0.25=111.25, the similarity value of the product image IMG5 is 50*1+30*0.25+120*0.25=87.5, the similarity value of the product image IMG6 is 10*1+5*0.25+8*0.25=13.25.

In another embodiment, when the selected type option 136 is determined as the searching option, the similarity comparison weight of the type option 136 is 1. The data comparison weights of the unselected searching options, such as the object identification option 126 and the keyword option 146, are determined as 0.25. Then, the similarity comparison values of the input image PIMG and the similarity comparison values of each product image IMG1-IMG6 are calculated according to the similarity comparison process corresponded to the type option 136, e.g. multiplying [180, 250, 150, 70, 30, 5] by the similarity comparison weight 1, and then adding the result of multiplying the data comparison values of input image PIMG and each produce image IMG1-IMG6 calculated by the data comparison processes separately corresponding to the object identification option 126 and the keyword option 146, such as similarity comparison values [300, 220, 150, 90, 50, 10] and data comparison values [150, 280, 350, 15, 120, 8], by the data comparison weight 0.25 and 0.25, so as to calculate the similarity value.

Based on above, the similarity value of the product image IMG1 is 292.5, the similarity value of the product image IMG2 is 375, the similarity value of the product image IMG3 is 275, the similarity value of the product image IMG4 is 96.25, the similarity value of the product image IMG5 is 72.5, the similarity value of the product image IMG6 is 9.5.

In another embodiment, when the selected keyword option 146 is determined as the searching option, the similarity comparison weight of the keyword option 146 is assigned as 1. The data comparison weights of the unselected searching options, such as the object identification option 126 and the type option 136, are assigned as 0.25. Then, the similarity comparison values of the input image PIMG and the similarity comparison values of each product image IMG1-IMG6 are calculated according to the similarity comparison process corresponded to the keyword option 146, e.g. multiplying [150, 280, 350, 15, 120, 8] by the similarity comparison weight 1, and then adding the result of multiplying the data comparison values of input image PIMG and each produce image IMG1-IMG6 calculated by the data comparison processes separately corresponding to the object identification option 126 and the type option 136, such as similarity comparison values [300, 220, 150, 90, 50, 10] and data comparison values [150, 280, 350, 15, 120, 8], by the data comparison weight 0.25 and 0.25, so as to calculate the similarity value.

Based on above, the similarity value of the product image IMG1 is 270, the similarity value of the product image IMG2 is 397.5, the similarity value of the product image IMG3 is 425, the similarity value of the product image IMG4 is 55, the similarity value of the product image IMG5 is 140, the similarity value of the product image IMG6 is 11.5.

The weights 1 and 0.25 mentioned above are only for the examples to describe the present invention. Other numbers, not limited to the above embodiments, can be used for representing the weights.

After calculating the similarity value in step 530, the product images are ordered according to the similarity value in a descending arrangement and the product image ranked in the front of the product images is transmitted to the client terminal in step 540. In above embodiment, when the object identification option 126 is selected as the searching option, the product image order can be IMG1, IMG2, IMG3, IMG4, IMG5 and IMG6. When the type option 136 is selected as the searching option, the product image order can be IMG2, IMG1, IMG3, IMG4, IMG5 and IMG6. When the keyword option 146 is selected as the searching option, the product image order can be IMG3, IMG2, IMG1, IMG5, IMG4 and IMG6. Finally, the product image ranked in the front of the product images is transmitted to the client terminal. In above embodiment, the three product images, such as product images IMG1, IMG2, IMG3, or IMG2, IMG1, IMG3, or IMG3, IMG2, IMG1, ranked in the front of all the product images are transmitted to the electronic device 110. The product images ranked prior and in the front of the product images are transmitted to the client terminal herein. Also, the system can select the first two product images ranked in the front of all the product images to transmit to the electronic device 110. Or, the system can select the first product image ranked in the front of all the product images to transmit to the electronic device 110. The method is not limited to the above embodiments.

In step 550, user determines that whether the received product image order meets the expectation. If the product image order meets the expectation, it means that user already finds the suitable product. And, the searching process is ended in step 560. If the produce image order does not meet the expectation, it means the searching option selected in step 520 is not suitable. In this moment, user can adjust the searching option in user interface 116, until the product image order meets the expectation.

Based on above descriptions and the detailed description of each embodiment, the searching method and the searching system of the present invention provide user selecting a searching option from multiple searching option corresponding to the input image and then performing the comparison process by comparing the input image and the searching data corresponding to the input image to the multiple product image included in the database and the multiple properties corresponding to the product image. In the end, user can obtain at least one product image according to the product image order.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A searching method for product images, comprising:
providing an input image, the input image being transmitted from a client terminal to a server and one of a plurality of searching options being selected by the client terminal;
analyzing the input image according to the searching options for obtaining searching data;
performing a comparison process, the input image and the searching data being compared with a plurality of product images and a plurality of properties corresponding to the product images in a database of the server during the comparison process; and
delivering at least one display product image to the client terminal for displaying.

2. The searching method for product images of claim 1, wherein each searching option is configured to have a weight, and the weight is adjustable by the client terminal.

3. The searching method for product images of claim 1, wherein the searching options comprise at least two of a style option, a brand option, a product name option, a type option, an image description option, an object identification option, a keyword option, a price option, and a place of origin option.

4. The searching method for product images of claim 1, wherein the comparison process comprises:
a similarity comparison process for obtaining a plurality of similarity comparison values by comparing the input images with the product images respectively; and
a data comparison process for obtaining a plurality of data comparison values by comparing the searching data with the properties corresponding to the product images respectively.

5. The searching method for product images of claim 4, further comprising:
assigning a similarity comparison weight and a data comparison weight when each searching option is selected;
obtaining a similarity value according to the similarity comparison weight and the data comparison weight corresponding to the selected searching option, wherein the similarity value is obtained by multiplying the similarity comparison values by the similarity comparison weight according to the selected searching option and then adding the data comparison value multiplying by the data comparison weight, so as to determine a product image order; and
delivering the product images in a descending arrangement according to the product image order; and transmitting the product image ranked in the front of the product images order to the client terminal for displaying.

6. A searching system for product images, comprising:
a server, comprising:
a database, comprising a plurality of product images, wherein each product image corresponding to a plurality of properties; and
a calculation comparison unit; and
an electronic device wirelessly communicated with the sever terminal, the electronic device comprising:
an image providing unit configured to provide an input image;
an input interface configured to provide a plurality of searching options for a user to select from; and
a control unit configured to transmit the input image and the searching options to the server;
wherein the calculation comparison unit of the server analyzes the input image to obtain searching data corresponding to the searching options, performs a comparison process of comparing the input image and the corresponding searching data with the product images and the corresponding properties in the database, so as to select at least one display product image from the product images, and deliver the at least one display product image to the electronic device for displaying.

7. The searching system for product images of claim 6, wherein the input interface further provides a weight for each searching option, and the weight is adjustable by the user.

8. The searching system for product images of claim 6, wherein the searching options comprise at least two of a style potion, a brand option, a product name option, a type option, an image description option, an object identification option, a keyword option, a price option, and a place of origin option.

9. The searching system for product images of claim 6, wherein the comparison process comprises:
a similarity comparison process for obtaining a plurality of similarity comparison values by comparing the input images with the product images respectively; and
a data comparison process for obtaining a plurality of data comparison values by comparing the searching data with the properties corresponding to the product images respectively.

10. The searching system for product images of claim 9, wherein a similarity comparison weight and a data comparison weight are assigned when each searching option is selected, the calculation comparison unit obtains a similarity value according to the similarity comparison weight and the data comparison weight corresponding to the selected searching option, wherein the similarity value is obtained by multiplying the similarity comparison values by the similarity comparison weight according to the selected searching option and then adding the data comparison value multiplying by the data comparison weight, so as to determine a product image order; and the calculation comparison unit delivers the product images in a descending arrangement according to the product image order and transmits the product image ranked in the front of the product images order to the client terminal for displaying.
